(19) United States
(12) Patent Application Publication
(10) Pub. No.: US 2025/0226404 A1
(43) Pub. Date: Jul. 10, 2025

(54) HIGH NICKEL CATHODE MATERIALS FOR BATTERY PACKS

(71) Applicant: MILWAUKEE ELECTRIC TOOL CORPORATION, Brookfield, WI (US)

(72) Inventors: Aditya Subramanian, Milwaukee, WI (US); Joshua P. Pender, Glendale, WI (US); Qingfang Shi, Brookfield, WI (US); Alexei Gavrilov, Hockessin, DE (US)

(21) Appl. No.: 18/852,656

(22) PCT Filed: Mar. 28, 2023
(86) PCT No.: PCT/US2023/065014

§ 371 Date: Sep. 30, 2024

Related U.S. Application Data
(60) Provisional application No. 63/326,102, filed on Mar. 31, 2022.

(51) Int. Cl. H01M 4/525; H01M 4/587; H01M 10/0587

(52) U.S. Cl. CPC H01M 4/525; H01M 4/587; H01M 10/0587

(57) ABSTRACT

Exemplary lithium-ion batteries comprise a cathode, an anode, and a non-aqueous electrolyte. Exemplary cathodes comprise a mixed metal oxide active material of formula:

LiNiₓM′₍₁₋ₓ₎O₂

wherein M′ is at least one metal element, and 0.60x≤0.999. Exemplary anodes comprise an active material, the active material comprising carbon.

### CROSS-REFERENCE TO RELATED APPLICATION(S)

This application claims priority to U.S. Provisional Patent Application No. 63/326,102 filed on Mar. 31, 2022, the entire contents of which are incorporated herein by reference.

### TECHNICAL FIELD

The present application relates generally to lithium-ion batteries comprising cathode active materials having high nickel (Ni) content, and battery packs containing the same.

### INTRODUCTION

Lithium-ion batteries provide power to many electrical devices used daily. There exists a need for lithium-ion batteries with improved electrochemical properties. The properties of the cathode, anode, and electrolyte can significantly affect battery performance.

### SUMMARY

Embodiments herein relate to lithium-ion batteries and battery packs including the same. In one aspect, a lithium-ion battery is disclosed. The lithium-ion battery may be a jelly-roll type lithium-ion battery. The lithium-ion battery may comprise a cathode, an anode, and a non-aqueous electrolyte. The cathode of the lithium-ion battery may comprise a mixed metal oxide active material of formula:

LiNiₓM′₍₁₋ₓ₎O₂

wherein M′ is at least one metal element, and 0.60≤x≤0.999. In various instances, 0.83≤x≤0.999. The anode of the lithium-ion battery may comprise an active material, the active material comprising carbon (i.e., “carbon-based active material”). The anode may further comprise silicon (Si). The anode may further comprise at least 4 weight % (wt%) Si.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting.

### BRIEF DESCRIPTION OF THE DRAWINGS

FIG. 1 illustrates a battery cell for a cell pouch, in accordance with some embodiments.

FIG. 2 illustrates a battery cell pouch, in accordance with some embodiments.

FIG. 3 illustrates a jelly-roll type battery cell, in accordance with some embodiments.

FIG. 4 illustrates the interior of a tabless jelly-roll type battery cell, in accordance with some embodiments.

FIG. 5 illustrates electrode sheets for a tabless battery cell, in accordance with some embodiments.

FIG. 6 illustrates a cathode tab arrangement for a tabbed battery cell, wherein the tabs are arranged in alignment, in accordance with some embodiments.

FIG. 7 illustrates an anode tab arrangement battery cell, wherein the tabs are arranged in a radial pattern, in accordance with some embodiments.

FIG. 8 illustrates a perspective view of a prismatic battery cell, in accordance with some embodiments.

FIG. 9 illustrates a fan fold (i.e., accordion fold or zigzag fold) electrode configuration prismatic battery cell, in accordance with some embodiments.

FIG. 10 illustrates a wound flat-wrap (WFW) electrode configuration for a prismatic battery cell, in accordance with some embodiments.

FIGS. 11-14 illustrate perspective views of exemplary battery packs, in accordance with some embodiments.

### DETAILED DESCRIPTION

Embodiments disclosed and contemplated herein generally relate to lithium-ion battery cells, and battery packs including the same. Exemplary lithium-ion batteries comprise a cathode, an anode, and a non-aqueous electrolyte. Exemplary cathodes of lithium-ion batteries comprise a mixed metal oxide active material of formula:

LiNiₓM′₍₁₋ₓ₎O₂

wherein M′ is at least one metal element, and 0.60≤x≤0.999. In various instances, 0.83≤x≤0.999. Exemplary anodes comprise an active material, the active material comprising carbon (i.e., “carbon-based active material”). Exemplary anodes further comprise silicon (Si). Exemplary anodes may comprise at least 4 wt % Si.

### I. Definitions

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “about” is used to indicate that exact values are not necessarily attainable. Therefore, the term “about” is used to indicate this uncertainty limit. The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5-1.4. The modifier “about” should also be considered as disclosing the range defined by the absolute values of the two endpoints. For example, the expression “from about 2 to about 4” also discloses the range “from 2 to 4.”

For the recitation of numeric ranges herein, each intervening number there between with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

The term “alkyl” means a straight or branched chain hydrocarbon. The term “C₁₋₄ alkyl” means a straight or branched chain hydrocarbon containing from 1 to 4 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

The term “alkyl” may be preceded by a designation indicating the number of atoms present in the group in a particular instance (e.g., “C₁₋₄ alkyl,”). These designations are used as generally understood by those skilled in the art. For example, the representation “C” followed by a subscripted number indicates the number of carbon atoms present in the group that follows. Thus, “C₃ alkyl” is an alkyl group with three carbon atoms (i.e., n-propyl, isopropyl). Where a range is given, as in “C₁₋₄,” the members of the group that follows may have any number of carbon atoms falling within the recited range. A “C₁₋₄alkyl,” for example, is an alkyl group having from 1 to 4 carbon atoms, however arranged (i.e., straight chain or branched).

The term “halogen” or “halo,” as used herein, means chlorine (Cl), bromine (Br), iodine (I), or fluorine (F). As used herein, “halogenated compound” (i.e., chlorinated, brominated, iodinated, or fluorinated) refers to a compound containing at least one halogen atom.

Unless specified or limited otherwise, the terms “mounted,” “connected,” “supported”, and “coupled” and variations thereof are used broadly and encompass both direct and indirect mountings, connections, Supports, and couplings. Further, “connected” and “coupled” are not restricted to physical or mechanical connections or couplings.

### II. Lithium-Ion Battery Cell Components

Lithium-ion batteries of the present disclosure comprise a cathode, an anode, and a non-aqueous electrolyte. Various aspects of exemplary cathodes, anodes, and non-aqueous electrolytes are discussed below.

### A. Cathode

Cathodes in lithium-ion batteries of the present disclosure generally comprise a cathode active material layer and a cathode current collector. Exemplary cathode active material layers of the present disclosure may comprise a cathode active material, a binder, and a conductive material.

The cathode active material layers of the present disclosure may comprise a mixed metal oxide active material. Typically, the mixed metal oxide active material of the cathode active materials of the present disclosure is a composition of formula:

LiNiₓM′₍₁₋ₓ₎O₂,

wherein M′ is at least one metal element and 0.60≤x≤0.999. In various instances, M′ may be Co, Mn, Al, Fe, Ti, Mg, Cr, Ga, Cu, Zn, Nb, V, Cu, Zr or combinations thereof. Relative stoichiometric amounts of nickel (Ni) and the at least one metal element, M′, are defined by subscript x. In various instances, 0.83≤x≤0.999. The mixed metal oxide active material may be a composition of formula LiNi_{0.83}M′_{0.17}O₂.

Furthermore, the mixed metal oxide active material may be a composition of formula:

LiNiₓCo_{y}M″_{(1-x-y)}O₂

wherein M″ is at least one metal element, 0.60≤x≤0.999 and 0.001≤y≤0.20. In various instances, M″ may be Mn, Al, Fe, Ti, Mg, Cr, Ga, Cu, Zn, Nb, V, Cu, Zr, or combinations thereof. Relative stoichiometric amounts of nickel (Ni), cobalt (Co), and M′ (the at least one metal element) are defined by subscripts x and y. In various instances, 0.83≤x≤0.999. The metal oxide active material may be a composition of formula LiNi_{0.83}Co_{y}M″_{(0.17-y)}O₂.

In various instances, the mixed metal oxide active material may be a composition of formula:

LiNiₓCo_{y}Mn_{(1-x-y)}O₂

wherein 0.60≤x≤0.999 and 0.001≤y≤0.20. Relative stoichiometric amounts of nickel (Ni), cobalt (Co), and manganese (Mn) are defined by subscripts x and y. Suitable mixed metal oxide active materials include, but are not limited to, lithium nickel cobalt manganese oxides (LiNiₓCo_{y}Mn_{(1-x-y)}O₂), such as LiNi_{0.8}Mn_{0.1}Co_{0.1}O₂ (NMC811). In various instances, 0.83≤x≤0.999. The mixed metal oxide active material may be a composition of formula LiNi_{0.83}Co_{y}Mn_{(0.17-y)}O₂ or a composition of formula LiNi_{0.83}Co_{y}Al_{(0.17-y)}O₂.

In various instances, the mixed metal oxide active material may be a composition of formula:

LiNiₓCo_{y}Al_{(1-x-y)}O₂

wherein 0.60≤x≤0.999 and 0.001≤y≤0.20. Relative stoichiometric amounts of nickel (Ni), cobalt (Co), and aluminum (Al) are defined by subscripts x and y. Suitable mixed metal oxide active materials include, lithium nickel cobalt aluminum oxides (LiNiₓCo_{y}Al_{(1-x-y)}O₂), such as LiNi_{0.8}Co_{0.15}Al_{0.05}O₂ (NCA), where 0.80≤x≤0.999. In various instances, 0.83≤x≤0.999. The mixed metal oxide active material may be a composition of formula LiNi_{0.83}Co_{y}Al_{(0.17-y)}O₂.

The mixed metal oxide active materials for cathode active material layers of the present disclosure may comprise varying amounts of nickel (Ni). A stoichiometric amount of nickel (Ni) is defined by the subscript x. Typically, x is between about 0.60 and about 0.999. In various instances, x is between about 0.6 and about 0.99; between about 0.65 and about 0.95; between about 0.70 and about 0.95; between about 0.70 and about 0.90; between about 0.75 and about 0.90; between about 0.75 and about 0.85; or between about 0.80 and about 0.85. In various instances, x is at least 0.60; at least 0.65; at least 0.70; at least 0.75; at least 0.80; at least 0.85; at least 0.90; at least 0.95; or at least 0.99. In various instances, x is no greater than 0.99; no greater than 0.95; no greater than 0.90; no greater than 0.85; no greater than 0.80; no greater than 0.75; no greater than 0.70; no greater than 0.65; or no greater than 0.60.

The mixed metal oxide active materials for cathode active material layers of the present disclosure may further comprise varying amounts of cobalt (Co). A stoichiometric amount of cobalt (Co) is defined by the subscript y. Typically, y is between about 0.001 and about 0.20. In various instances y is between about 0.0025 and about 0.20; between about 0.005 and about 0.20; between about 0.01 and about 0.15; between about 0.015 and about 0.15; between about 0.02 and about 0.10; between about 0.025 and about 0.10; or between about 0.025 and about 0.075. In various instances, y is at least 0.0025; at least 0.005; at least 0.01; at least 0.025; at least 0.05; at least 0.075; at least 0.1; at least 0.15; or at least 0.20. In various instances, y is no greater than 0.20; no greater than 0.15; no greater than 0.1; no greater 0.075; no greater than 0.05; no greater than 0.025; no greater than 0.02; no greater than 0.015; no greater than 0.01; no greater than 0.005; or no greater than 0.0025.

The form of the mixed metal oxide active material present in the cathode active material layers of the present disclosure may vary. When the mixed metal oxide active material is present in particle form, the active material particle shape may be any of massive, polyhedral, spherical, ellipsoidal, platy, acicular, columnar, and other shapes such as those in common use. In electrochemical elements, the active material in each electrode usually expands/contracts with the charge/discharge of the element and, hence, deterioration is apt to occur, such as active-material breakage and conduction path breakage, due to the stress caused by the expansion/contraction.

The mixed metal oxide active material present in cathode active material layers of the present disclosure may be manufactured using methods known to those of skill in the art.

In some instances, the mixed metal oxide active material may be manufactured as particles. The manufactured mixed metal oxide active material particles may be primary particles. In various instances, the mixed metal oxide active material particles may be manufactured using methods that are known by those of skill in the art to increase Li-ion transport, mechanical strength, and thermal stability, and reduce strain for the cathode active material layer during charging/discharging (e.g., nanosizing the primary particles, controlling the shape/alignment of the particles, using single-crystal particles).

In various instances, a substance having a composition different from that of the mixed metal oxide active material is coated onto said mixed metal oxide active material to form a coating. Said coating may function or be applied to protect and/or stabilize the mixed metal oxide active material during battery use. The coating for the mixed metal oxide active material may be specifically formulated to prevent the non-aqueous electrolyte from undergoing an oxidation reaction on the surface of the cathode active material layer, thus improving battery life.

Coatings for mixed metal oxide active materials of the present disclosure may comprise ionically conductive inorganic materials (e.g., oxides, fluorides, phosphates, sulfides, nitrides, oxynitride and oxysulfide glasses, silicates and thio-silicates, LISICON (chemical formula of Li₂₊₂ₓZn₁₋ₓGeO₄), thio-LISICON structures (chemical formula of Li₍₄₋ₓ₎Ge₍₁₋ₓ₎PₓS₄)), ionically/electrically conductive polymers (e.g., polyanilines, polypyrroles, polythiophenes, polycarbazols, polyazephines, polyindoles, polyphenylenesulfides), and/or carbon (e.g., graphene, amorphous carbon). Exemplary oxides that may be used as the coating for the mixed metal oxide active materials include aluminum oxide, silicon oxide, titanium oxide, zirconium oxide, magnesium oxide, calcium oxide, boron oxide, antimony oxide, and bismuth oxide, sulfates such as lithium sulfate, sodium sulfate, potassium sulfate, magnesium sulfate, calcium sulfate, and aluminum sulfate, and carbonates such as lithium carbonate, calcium carbonate, and magnesium carbonate.

The cathode active material layers of cathodes of the present disclosure may comprise varying amounts of mixed metal oxide active material. In various instances, the cathode active material layer may comprise 90 wt % to 99 wt % mixed metal oxide active material. In various instances, the cathode active material layer may comprise 90 wt % to 98.5 wt % mixed metal oxide active material; 90.5 wt % to 98 wt % mixed metal oxide active material; 91 wt % to 97.5 wt % mixed metal oxide active material; 91.5 wt % to 97 wt % mixed metal oxide active material; 92 wt % to 96.5 wt % mixed metal oxide active material; 92.5 wt % to 96 wt % mixed metal oxide active material; 93 wt % to 96.5 wt % mixed metal oxide active material; or 93 wt % to 96 wt % mixed metal oxide active material. In various instances, the cathode active material layer may comprise no greater than 99 wt % mixed metal oxide active material; no greater than 98.5 wt % mixed metal oxide active material; no greater than 98 wt % mixed metal oxide active material; no greater than 97.5 wt % mixed metal oxide active material; no greater than 96 wt % mixed metal oxide active material; no greater than 95.5 wt % mixed metal oxide active material; no greater than 95 wt % mixed metal oxide active material; no greater than 94.5 wt % mixed metal oxide active material; no greater than 94 wt % mixed metal oxide active material; no greater than 93.5 wt % mixed metal oxide active material; no greater than 93 wt % mixed metal oxide active material; no greater than 92.5 wt % mixed metal oxide active material; no greater than 92 wt % mixed metal oxide active material; no greater than 91.5 wt % mixed metal oxide active material; no greater than 91 wt % mixed metal oxide active material; no greater than 90.5 wt % mixed metal oxide active material; or no greater than 90 wt % mixed metal oxide active material. In various instances, the cathode active material layer may comprise no less than 90 wt % mixed metal oxide active material; no less than 90.5 wt % mixed metal oxide active material; no less than 91 wt % mixed metal oxide active material; no less than 91.5 wt % mixed metal oxide active material; no less than 92 wt % mixed metal oxide active material; no less than 92.5 wt % mixed metal oxide active material; no less than 93 wt % mixed metal oxide active material; no less than 93.5 wt % mixed metal oxide active material; no less than 94 wt % mixed metal oxide active material; no less than 94.5 wt % mixed metal oxide active material; no less than 95 wt % mixed metal oxide active material; no less than 95.5 wt % mixed metal oxide active material; no less than 96 wt % mixed metal oxide active material; no less than 96.5 wt % mixed metal oxide active material; no less than 97 wt % mixed metal oxide active material; no less than 97.5 wt % mixed metal oxide active material; no less than 98 wt % mixed metal oxide active material; no less than 98.5 wt % mixed metal oxide active material; or no less than 99 wt % mixed metal oxide active material.

The cathode active material layers for cathodes of the present disclosure may further comprise at least one binder and at least one conductive material.

Binders that may be used for cathode active material layers of the present disclosure include, but are not limited to, thermoplastic polymers such as polyethylene, polypropylene, polyethylene terephthalate (PET), polyether nitrile, polyacrylonitrile, polyimide, polyamide, cellulose, carboxymethyl cellulose (CMC) and salts thereof, ethylene-vinyl acetate copolymer, polyvinyl chloride, styrene-butadiene rubber (SBR), isoprene rubber, butadiene rubber, ethylene-propylene rubber, ethylene-propylene-diene copolymer, styrene-butadiene-styrene block copolymer and hydrogen additives thereof, styrene-isoprene-styrene block copolymer and hydrogen additives thereof, fluoride resins such as polyvinylidene-fluoride (PVDF), polytetrafluoroethylene (PTFE), tetrafluoroethylene-hexafluoropropylene copolymer (FEP), tetrafluoroethylene-perfluoroalkyl vinylether copolymer (PFA), ethylene-tetrafluoroethylene copolymer (ETFE), polychlorotrifluoroethylene (PCTFE), ethylene-chlorotrifluoroethylene copolymer (ECTFE), polyvinyl fluoride (PVF); vinylidenefluoride fluororubbers such as vinylidenefluoride-hexafluoropropylene fluororubber (VDF-HFP fluororubber), vinylidenefluoride-hexafluoropropylene-tetrafluoroethylene fluororubber (VDF-HFP-TFE fluororubber), vinylidenefluoride-pentafluoropropylene fluororubber (VDF-PFP fluororubber), vinylidenefluoride-pentafluoropropylene-tetraflouroethylene fluororubber (VDF-PFP-TFE fluororubber), vinylidenefluoride-perfluoromethyl vinylether-tetrafluoroethylene fluororubber (VDF-PFMVE-TFE fluororubber), vinylidenefluoride-chlorotrifluoroethylene fluororubber (VDF-CTFE fluororubber); epoxy resin, and polyacrylic acid (PAA). These binders may be used individually, or two or more types may be used in combination. In various instances, the binder may comprise polyvinyl fluoride (PVDF). In various instances, the binder may comprise polyacrylic acid (PAA), styrene butadiene rubber (SBR), carboxymethyl cellulose (CMC), or combinations thereof.

Cathode active material layers for cathodes of the present disclosure may comprise 0.5 to 5 wt % binder. In various instances, the cathode active material layer may comprise 0.5 to 4.5 wt % binder; 0.5 to 4.0 wt % binder; 1.0 to 4.0 wt % binder; 1.0 to 3.5 wt % binder; 1.5 to 3.5 wt % binder; 1.5 to 3.0 wt % binder; 1.0 to 3.0 wt % binder; 1.0 to 2.5 wt % binder; or 1.5 to 2.5 wt % binder. In various instances, the cathode active material layer may comprise no greater than 5 wt % binder; no greater than 4.5 wt % binder; no greater than 4 wt % binder; no greater than 3.5 wt % binder; no greater than 3 wt % binder; no greater than 2.5 wt % binder; no greater than 2 wt % binder; no greater than 1.5 wt % binder; no greater than 1 wt % binder; or no greater than 0.5 wt % binder. In various instances, the cathode active material layer may comprise no less than 0.5 wt % binder; no less than 1 wt % binder; no less than 1.5 wt % binder; no less than 2 wt % binder; no less than 2.5 wt % binder; no less than 3 wt % binder; no less than 3.5 wt % binder; no less than 4 wt % binder; no less than 4.5 wt % binder; or no less than 5 wt % binder.

Suitable conductive materials for cathode active material layers of the present disclosure include carbon-based conductive materials, such as carbon black, acetylene black, ketjen black, carbon fiber, carbon nanotubes, carbon nanotubes, graphene, and combinations thereof. In various instances, the conductive material may comprise carbon black, graphite, carbon nanotubes, or combinations thereof.

The cathode active material layer may comprise 0.5 to 5 wt % conductive material. In various instances, the cathode active material layer may comprise 0.5 to 4.5 wt % conductive material; 0.5 to 4.0 wt % conductive material; 1.0 to 4.0 wt % conductive material; 1.0 to 3.5 wt % conductive material; 1.5 to 3.5 wt % conductive material; 1.5 to 3.0 wt % conductive material; 1.0 to 3.0 wt % conductive material; 1.0 to 2.5 wt % conductive material; or 1.5 to 2.5 wt % conductive material. In various instances, exemplary cathode active material layers may comprise no greater than 5 wt % conductive material; no greater than 4.5 wt % conductive material; no greater than 4 wt % conductive material; no greater than 3.5 wt % conductive material; no greater than 3 wt % conductive material; no greater than 2.5 wt % conductive material; no greater than 2 wt % conductive material; no greater than 1.5 wt % conductive material; no greater than 1 wt % conductive material; or no greater than 0.5 wt % conductive material. In various instances, the cathode active material layer may comprise no less than 0.5 wt % conductive material; no less than 1 wt % conductive material; no less than 1.5 wt % conductive material; no less than 2 wt % conductive material; no less than 2.5 wt % conductive material; no less than 3 wt % conductive material; no less than 3.5 wt % conductive material; no less than 4 wt % conductive material; no less than 4.5 wt % conductive material; or no less than 5 wt % conductive material.

The cathode active material layer may further comprise additional cathode additive materials (e.g., Li₂CO₃). Such additives will depend on the battery-cell type and the intended use for said battery.

Cathodes of the present disclosure are manufactured by using methods known to those of skill in the art. The cathode active material layer may typically be applied in slurry form onto the cathode current collector, then dried, thus forming the cathode. Materials that may constitute the cathode current collector are not particularly limited. In various instances, a metal current collector may be used as the cathode current collector. Specific examples of metals that may be used for the current collector include aluminum, nickel, iron, titanium, copper, stainless steel, and other alloys. In addition to the above, a cladding material of nickel and aluminum, a cladding material of copper and aluminum, or plating material of a combination of these metals may be used. In various instances, copper, aluminum, stainless steel, or combinations thereof may be used. In various instances, the cathode current collector may comprise an aluminum foil.

In some instances, cathode current collectors of the present disclosure may be coated foils. Coatings for current collectors of the present disclosure may be carbon-based.

Cathode current collectors of the present disclosure may have various thicknesses. The thickness of the current collector may be determined and modified according to the intended use of the battery.

For instance, the cathode current collector may have a thickness of 0.5 μm to 20 μm. In various instances, the cathode current collector may have a thickness of 0.5 μm to 15 μm; 0.5 μm to 14 μm; 1 μm to 13 μm; 1 μm to 12 μm; 2 μm to 11 μm; 2 μm to 10 μm; 3 μm to 9 μm; 3 μm to 8 μm; 4 μm to 7 μm; or 5 μm to 7 μm. In various instances, the cathode current collector may have a thickness of no greater than 15 μm; no greater than 14 μm; no greater than 13 μm; no greater than 12 μm; no greater than 11 μm; no greater than 10 μm; no greater than 9 μm; no greater than 8 μm; no greater than 7 μm; no greater than 6 μm; no greater than 5 μm; no greater than 4 μm; no greater than 3 μm; no greater than 2 μm; no greater than 1 μm; or no greater than 0.5 μm. In various instances, the cathode current collector may have a thickness of no less than 0.5 μm; no less than 1 μm; no less than 2 μm; no less than 3 μm; no less than 4 μm; no less than 5 μm; no less than 6 μm; no less than 7 μm; no less than 8 μm; no less than 9 μm; no less than 10 μm; no less than 11 μm; no less than 12 μm; no less than 13 μm; no less than 14 μm; or no less than 15 μm.

Cathodes for lithium-ion batteries of the present disclosure may discharge varying current densities (mA/cm²). The current density varies depending on factors such as battery cell size, and battery pack design. In various instances, the cathode may discharge from 5 mA/cm² to 50 mA/cm². In various instances, the cathode may discharge from 5 mA/cm² to 45 mA/cm²; 10 mA/cm² to 45 mA/cm²; 15 mA/cm² to 40 mA/cm²; 20 mA/cm² to 40 mA/cm²; 25 mA/cm² to 35 mA/cm²; or 30 mA/cm² to 35 mA/cm². In various instances, the cathode may discharge at least 5 mA/cm²; at least 10 mA/cm²; at least 15 mA/cm²; at least 20 mA/cm²; at least 25 mA/cm²; at least 30 mA/cm²; at least 31 mA/cm²; at least 32 mA/cm²; at least 33 mA/cm²; at least 34 mA/cm²; at least 35 mA/cm²; at least 36 mA/cm²; at least 37 mA/cm²; at least 38 mA/cm²; at least 39 mA/cm²; at least 40 mA/cm²; at least 41 mA/cm²; at least 42 mA/cm²; at least 43 mA/cm²; at least 44 mA/cm²; or at least 45 mA/cm².

The cathode for lithium-ion batteries of the present disclosure may deliver varying Watts (Wh) per cubic centimeter (cm³ or cc). In various instances, the cathode may deliver no less than 1.0 Wh/cc; no less than 1.1 Wh/cc; no less than 1.2 Wh/cc; no less than 1.3 Wh/cc; no less than 1.4 Wh/cc; no less than 1.5 Wh/cc; no less than 1.6 Wh/cc; no less than 1.7 Wh/cc; no less than 1.8 Wh/cc; no less than 1.9 Wh/cc; no less than 2.0 Wh/cc; no less than 2.1 Wh/cc; no less than 2.2 Wh/cc; no less than 2.3 Wh/cc; no less than 2.4 Wh/cc; no less than 2.5 Wh/cc; no less than 2.6 Wh/cc; no less than 2.7 Wh/cc; no less than 2.8 Wh/cc; no less than 2.9 Wh/cc; or no less than 3.0 Wh/cc. Exemplary cathodes may deliver no less than 1.9 Wh/cc.

### B. Anode

The anodes of the lithium-ion batteries of the present disclosure generally comprise an anode active material layer and an anode current collector. Exemplary anode active material layers of the present disclosure may comprise an anode active material, a binder, and a conductive material.

Anode active material layers for anodes of the present disclosure comprise an anode active material comprising carbon (i.e., “carbon-based active material”).

The carbon-based active material for anodes of the present disclosure may be selected from:
(1) natural graphites;
(2) artificial carbonaceous substances and artificial graphitic substances; and carbon materials obtained by subjecting carbonaceous substances [e.g., natural graphites, coal coke, petroleum coke, coal pitch, petroleum pitch, carbonaceous substances obtained by oxidizing these pitches, needle coke, pitch coke, carbon materials obtained by partly graphitizing these cokes, products of the pyrolysis of organic substances, such as furnace black, acetylene black, and pitch-derived carbon fibers, organic substances capable of carbonization (e.g., coal tar pitches ranging from soft pitch to hard pitch, coal-derived heavy oil such as dry distillation/liquefaction oil, straight-run heavy oil such as topping residues and vacuum distillation residues, heavy oils resulting from petroleum cracking, such as ethylene tar as a by-product of the thermal cracking of crude oil or naphtha, aromatic hydrocarbons such as acenaphthylene, decacyclene, anthracene, and phenanthrene, nitrogen-ring compounds such as phenazine and acridine, sulfur-ring compounds such as thiophene and bithiophene, polyphenylenes such as biphenyl and terphenyl, poly(vinyl chloride), poly(vinyl alcohol), poly(vinyl butyral), substances obtained by insolubilizing these compounds, nitrogen-containing organic polymers such as polyacrylonitrile and polypyrrole, sulfur-containing organic polymers such as polythiophene, organic polymers such as polystyrene, natural polymers such as polysaccharides represented by cellulose, lignin, mannan, poly(galacturonic acid), chitosan, and saccharose, thermoplastic resins such as poly(phenylene sulfide) and poly(phenylene oxide), and thermosetting resins such as furfuryl alcohol resins, phenol-formaldehyde resins, and imide resins) and products of the carbonization thereof, or solutions obtained by dissolving any of such organic substances capable of carbonization in a low-molecular organic solvent, e.g., benzene, toluene, xylene, quinoline, or n-hexane, and products of the carbonization of these solutions] to a heat treatment at a temperature in the range of from 400° C. to 3,200° C. one or more times;
(3) carbon materials constituting a negative-electrode active-material layer which comprise at least two carbonaceous substances differing in crystallinity and/or have an interface where at least two carbonaceous substances differing in crystallinity are in contact with each other; and
(4) carbon materials constituting a negative-electrode active-material layer which comprise at least two carbonaceous substances differing in orientation and/or have an interface where at least two carbonaceous substances differing in orientation are in contact with each other. This is because this carbonaceous material brings about a satisfactory balance between initial irreversible capacity and high-current-density charge/discharge characteristics. In various instances, the carbon-based active material is a natural or an artificial graphite.

Anode active material layers of the present disclosure may comprise 90 wt % to 99 wt % carbon-based active material. In various instances, anode active material layers of the present disclosure may comprise 90 wt % to 98.5 wt % carbon-based active material; 90.5 wt % to 98 wt % carbon-based active material; 91 wt % to 97.5 wt % carbon-based active material; 91.5 wt % to 97 wt % carbon-based active material; 92 wt % to 96.5 wt % carbon-based active material; 92.5 wt % to 96 wt % carbon-based active material; 93 wt % to 96.5 wt % carbon-based active material; or 93 wt % to 96 wt % carbon-based active material. In various instances, anode active material layers of the present disclosure may comprise no greater than 99 wt % carbon-based active material; no greater than 98.5 wt % carbon-based active material; no greater than 98 wt % carbon-based active material; no greater than 97.5 wt % carbon-based active material; no greater than 96 wt % carbon-based active material; no greater than 95.5 wt % carbon-based active material; no greater than 95 wt % carbon-based active material; no greater than 94.5 wt % carbon-based active material; no greater than 94 wt % carbon-based active material; no greater than 93.5 wt % carbon-based active material; no greater than 93 wt % carbon-based active material; no greater than 92.5 wt % carbon-based active material; no greater than 92 wt % carbon-based active material; no greater than 91.5 wt % carbon-based active material; no greater than 91 wt % carbon-based active material; no greater than 90.5 wt % carbon-based active material; or no greater than 90 wt % carbon-based active material. In various instances, anode active material layers of the present disclosure may comprise no less than 90 wt % anode active material; no less than 90.5 wt % carbon-based active material; no less than 91 wt % carbon-based active material; no less than 91.5 wt % carbon-based active material; no less than 92 wt % carbon-based active material; no less than 92.5 wt % carbon-based active material; no less than 93 wt % carbon-based active material; no less than 93.5 wt % carbon-based active material; no less than 94 wt % carbon-based active material; no less than 94.5 wt % carbon-based active material; no less than 95 wt % carbon-based active material; no less than 95.5 wt % carbon-based active material; no less than 96 wt % carbon-based active material; no less than 96.5 wt % carbon-based active material; no less than 97 wt % carbon-based active material; no less than 97.5 wt % carbon-based active material; no less than 98 wt % carbon-based active material; no less than 98.5 wt % carbon-based active material; or no less than 99 wt % carbon-based active material.

The carbon-based active material comprises a carbonaceous material and varying amounts of silicon (Si).

In various instances, the carbon-based active material of the present disclosure further comprises varying amounts of silicon (Si). In various instances, carbon-based active material of the present disclosure comprises at least 1 weight % (wt%) silicon (Si). In various instances, the carbon-based active material of the present disclosure comprises at least 1 wt % Si; at least 1.5 wt % Si; at least 2 wt % Si; at least 2.5 wt % Si; at least 3 wt % Si; at least 3.5 wt % Si; at least 4 wt % Si; at least 4.5 wt % Si; at least 5 wt %; at least 5.5 wt %; at least 6 wt % Si; at least 6.5 wt % Si; at least 7 wt % Si; at least 7.5 wt % Si; at least 8 wt % Si; at least 8.5 wt % Si; at least 9 wt %; at least 9.5 wt %; or at least 10 wt % Si.

In various instances, the anode active material layer does not contain any Si. In other instances, the anode active material layer comprises at least 4 wt % Si.

The anode active material layer of the present disclosure may further comprise at least one binder and at least one conductive material.

Anode active material layers for anodes of the present disclosure may further comprise one or more binders. Binders that may be used for the anode active material layer include, but are not limited to, thermoplastic polymers such as polyethylene, polypropylene, polyethylene terephthalate (PET), polyether nitrile, polyacrylonitrile, polyimide, polyamide, cellulose, carboxymethyl cellulose (CMC) and salts thereof, ethylene-vinyl acetate copolymer, polyviynyl chloride, styrene-butadiene rubber (SBR), isoprene rubber, butadiene rubber, ethylene-propylene rubber, ethylene-propylene-diene copolymer, styrene-butadiene-styrene block copolymer and hydrogen additives thereof, styrene-isoprene-styrene block copolymer and hydrogen additives thereof, fluoride resins such as polyvinylidene-fluoride (PVDF), polytetrafluoroethylene (PTFE), tetrafluoroethylene-hexafluoropropylene copolymer (FEP), tetrafluoroethylene-perfluoroalkyl vinylether copolymer (PFA), ethylene-tetrafluoroethylene copolymer (ETFE), polychlorotrifluoroethylene (PCTFE), ethylene-chlorotrifluoroethylene copolymer (ECTFE), polyvinyl fluoride (PVF); vinylidenefluoride fluororubbers such as vinylidenefluoride-hexafluoropropylene fluororubber (VDF-HFP fluororubber), vinylidenefluoride-hexafluoropropylene-tetrafluoroethylene fluororubber (VDF-HFP-TFE fluororubber), vinylidenefluoride-pentafluoropropylene fluororubber (VDF-PFP fluororubber), vinylidenefluoride-pentafluoropropylene-tetraflouroethylene fluororubber (VDF-PFP-TFE fluororubber), vinylidenefluoride-perfluoromethyl vinylether-tetrafluoroethylene fluororubber (VDF-PFMVE-TFE fluororubber), vinylidenefluoride-chlorotrifluoroethylene fluororubber (VDF-CTFE fluororubber); epoxy resin, and polyacrylic acid (PAA). These binders may be used individually, or two or more types may be used in combination. In various instances, the binder may comprise polyvinyl fluoride (PVDF). In various instances, the binder may comprise polyacrylic acid (PAA), styrene butadiene rubber (SBR), carboxymethyl cellulose (CMC), or combinations thereof.

Anode active material layers of the present disclosure may comprise 0.5 to 5 wt % binder. In various instances, the anode active material layer may comprise 0.5 to 4.5 wt % binder; 0.5 to 4.0 wt % binder; 1.0 to 4.0 wt % binder; 1.0 to 3.5 wt % binder; 1.5 to 3.5 wt % binder; 1.5 to 3.0 wt % binder; 1.0 to 3.0 wt % binder; 1.0 to 2.5 wt % binder; or 1.5 to 2.5 wt % binder. In various instances, exemplary anode active material layers may comprise no greater than 5 wt % binder; no greater than 4.5 wt % binder; no greater than 4 wt % binder; no greater than 3.5 wt % binder; no greater than 3 wt % binder; no greater than 2.5 wt % binder; no greater than 2 wt % binder; no greater than 1.5 wt % binder; no greater than 1 wt % binder; or no greater than 0.5 wt % binder. In various instances, exemplary anode active material layers may comprise no less than 0.5 wt % binder; no less than 1 wt % binder; no less than 1.5 wt % binder; no less than 2 wt % binder; no less than 2.5 wt % binder; no less than 3 wt % binder; no less than 3.5 wt % binder; no less than 4 wt % binder; no less than 4.5 wt % binder; or no less than 5 wt % binder.

Suitable conductive materials for anode active material layers of the present disclosure include carbon-based conductive materials, such as carbon black, acetylene black, ketjen black, carbon fiber, carbon nanotubes, carbon nanotubes, graphene, and combinations thereof. In various instances, the conductive material may comprise carbon black, graphite, carbon nanotubes, or combinations thereof.

Anode active material layers of the present disclosure may comprise 0.5 to 5 wt % conductive material. In various instances, the anode active material layer may comprise 0.5 to 4.5 wt % conductive material; 0.5 to 4.0 wt % conductive material; 1.0 to 4.0 wt % conductive material; 1.0 to 3.5 wt % conductive material; 1.5 to 3.5 wt % conductive material; 1.5 to 3.0 wt % conductive material; 1.0 to 3.0 wt % conductive material; 1.0 to 2.5 wt % conductive material; or 1.5 to 2.5 wt % conductive material. In various instances, the anode active material layer may comprise no greater than 5 wt % conductive material; no greater than 4.5 wt % conductive material; no greater than 4 wt % conductive material; no greater than 3.5 wt % conductive material; no greater than 3 wt % conductive material; no greater than 2.5 wt % conductive material; no greater than 2 wt % conductive material; no greater than 1.5 wt % conductive material; no greater than 1 wt % conductive material; or no greater than 0.5 wt % conductive material. In various instances, the anode active material layer may comprise no less than 0.5 wt % conductive material; no less than 1 wt % conductive material; no less than 1.5 wt % conductive material; no less than 2 wt % conductive material; no less than 2.5 wt % conductive material; no less than 3 wt % conductive material; no less than 3.5 wt % conductive material; no less than 4 wt % conductive material; no less than 4.5 wt % conductive material; or no less than 5 wt % conductive material.

The anode active material layer may further comprise additional anode additive materials (e.g., Li₂CO₃). Such additives will depend on the battery-cell type and the intended use for said battery.

Anodes of the present disclosure are manufactured by using methods known to those of skill in the art. The anode active material layer is typically be applied in slurry-form onto an anode current collector, then dried, thus forming the anode. Materials that may constitute the anode current collectors of the present disclosure are not particularly limited. A metal current collector may be used as the anode current collector. Specific examples of metals that may be used for the current collector include aluminum, nickel, iron, titanium, copper, stainless steel, and other alloys. In addition to the above, a cladding material of nickel and aluminum, a cladding material of copper and aluminum, or plating material of a combination of these metals may be used. The metal may be a foil obtained by coating aluminum on the surface thereof. Specific examples of metals include aluminum, nickel, iron, titanium, copper, stainless steel, and other alloys. In addition to the above, a cladding material of nickel and aluminum, a cladding material of copper and aluminum, or plating material of a combination of these metals may be used. In various instances, copper, aluminum, stainless steel, or combinations thereof may be used as the foil material. In various instances, the anode current collector may comprise a copper foil.

In some instances, the anode current collectors may be a coated foil. The current collector coating may be carbon-based.

Anode current collectors of the present disclosure may have various thicknesses. The thickness of the current collector may be determined and modified according to the intended use of the battery.

For instance, the anode current collector may have a thickness of 0.5 μm to 20 μm. In various instances, the anode current collector may have a thickness of 0.5 μm to 15 μm; 0.5 μm to 14 μm; 1 μm to 13 μm; 1 μm to 12 μm; 2 μm to 11 μm; 2 μm to 10 μm; 3 μm to 9 μm; 3 μm to 8 μm; 4 μm to 7 μm; or 5 μm to 7 μm. In various instances, the anode current collector may have a thickness of no greater than 15 μm; no greater than 14 μm; no greater than 13 μm; no greater than 12 μm; no greater than 11 μm; no greater than 10 μm; no greater than 9 μm; no greater than 8 μm; no greater than 7 μm; no greater than 6 μm; no greater than 5 μm; no greater than 4 μm; no greater than 3 μm; no greater than 2 μm; no greater than 1 μm; or no greater than 0.5 μm. In various instances, the anode current collector may have a thickness of no less than 0.5 μm; no less than 1 μm; no less than 2 μm; no less than 3 μm; no less than 4 μm; no less than 5 μm; no less than 6 μm; no less than 7 μm; no less than 8 μm; no less than 9 μm; no less than 10 μm; no less than 11 μm; no less than 12 μm; no less than 13 μm; no less than 14 μm; or no less than 15 μm.

### C. Non-Aqueous Electrolyte

Non-aqueous electrolytes for lithium-ion batteries of the present disclosure are not particularly limited. Generally, non-aqueous electrolytes comprise at least one lithium (Li) salt and a non-aqueous solvent. The non-aqueous electrolyte may further comprise at least one additive.

Non-aqueous electrolytes for lithium-ion batteries of the present disclosure comprise at least one lithium (Li) salt. In various instances, non-aqueous electrolytes of the present disclosure comprise more than one lithium salt. Suitable lithium salts for non-aqueous electrolytes of the present disclosure include inorganic fluoride salts such as LiPF₆, LiBF₄, LiAsF₆, and LiSbF₆; perhalogen acid salts such as LiClO₄, LiBrO₄, and LiIO₄; and inorganic chloride salts such as LiAlCl₄.

Exemplary non-aqueous electrolytes may comprise at least one fluorinated lithium salt. The lithium salt may be a fluorine-containing organolithium salt selected from a perfluoroalkanesulfonic acid salt such as LiCF₃SO₃; a perfluoroalkanesulfonylimide salts such as LiN(CF₃SO₂)₂, LiN(CF₃CF₂SO₂)₂, or LiN(CF₃SO₂)(C₄F₉SO₂); a perfluoroalkanesulfonyl methide salt such as LiC(CF₃SO₂)₃; a fluoroalkyl fluorophosphate such as Li[PF₅((CF₂)₂CF₃)], Li[PF₄((CF₂)₂CF₃)₂], Li[PF₃((CF₂)₂CF₃)₃], Li[PF₅((CF₂)₃CF₃)], Li[PF₄((CF₂)₃CF₃)₂], or Li[PF₃((CF₂)₃CF₃)₃], or combinations thereof.

In various instances, the total concentration of the lithium salt in the non-aqueous electrolyte of the present disclosure ranges from 0.8 M to 4.0 M. In various instances the total concentration of the lithium salt may range from 1.0 M to 4.0 M; 1.0 M to 3.75 M; 1.25 M to 3.75 M; 1.25 M to 3.5 M; from 1.5 M to 3.5 M; from 1.5 M to 3.25 M; from 1.75 M to 3.25 M; from 1.75 M to 3.0 M; from 2.0 M to 3.0 M; from 2.0 M to 2.75 M; or from 2.25 M to 2.75 M. In various instances, the total concentration of the lithium salt is at least 1.0 M; at least 1.25 M; at least 1.5 M; at least 2.0 M; at least 2.5 M; at least 2.75 M; at least 3.0 M; at least 3.25 M; at least 3.5 M; at least 3.75 M; or at least 4.0 M. In various instances, the total concentration of the lithium salt is no greater than 4.0 M; no greater than 3.75 M; no greater than 3.5 M; no greater than 3.25 M; no greater than 3.0 M; no greater than 2.75 M; no greater than 2.5 M; no greater than 2.25 M; no greater than 2.0 M; no greater than 1.75 M; no greater than 1.5 M; or no greater than 1.0 M. Exemplary non-aqueous electrolytes of the present disclosure have a total concentration of the lithium salt of at least 2.0 M.

In various instances, the non-aqueous electrolyte of the present disclosure may comprise at least one phosphorous-based lithium salt, such as lithium hexafluorophosphate (LiPF₆), lithium difluorophosphate (LiPF₂O₂), or combinations thereof.

In various instances, the non-aqueous electrolyte of the present disclosure may comprise at least one boron-based lithium salt, such as lithium bis (oxalato) borate (LiBOB), lithium difluoro(oxalato)borate (LiDFOB), or combinations thereof.

In various instances, at the non-aqueous electrolyte of the present disclosure may comprise at least one imide-based lithium salt, such as LiN(SO₂F)₂, LiN(SO₂CF₃)₂, LiN(SO₂C₂F₅)₂, (CF₂)₂(SO₂)₂NLi (cyclic), (CF₂)₃(SO₂)₂NLi (cyclic), LiC(SO₂CF₃)₃, or combinations thereof.

In various instances, exemplary electrolytes may comprise at least one phosphorous-based lithium salt, at least one boron-based lithium salt, and at least one imide-based lithium salt. For instance, exemplary electrolytes may comprise lithium bis(trifluoromethanesulfonyl)imide (LIFSI), lithium hexafluorophosphate (LiPF₆), lithium difluorophosphate (LiPF₂O₂), or a combination thereof, and lithium bis(oxalato)borate (LiBOB), lithium difluoro(oxalato)borate (LiDFOB), or a combination thereof.

Non-aqueous electrolytes for lithium-ion batteries of the present disclosure comprise a non-aqueous solvent. In various instances, the non-aqueous solvent of the electrolyte may comprise an ester, a carbonate, an ether, an amide, a sulfone, a lactone, a phosphate, an ionic liquid, or combinations thereof. At least one solvent used in the non-aqueous solvent may be an ester. At least one solvent used in the non-aqueous solvent may be a linear carbonate, a cyclic carbonate, or a combination thereof. At least one solvent used in the non-aqueous solvent may be a fluorinated solvent. At least one solvent used in the non-aqueous solvent may be a solvent containing a phosphate group. At least one solvent used in the non-aqueous solvent may be an ionic liquid.

In various instances, non-aqueous electrolyte solvents for the non-aqueous electrolyte of the present disclosure may comprise an ester. The ester may be a halogenated or a non-halogenated ester. A halogenated ester is an ester than contains at least one halogen atom (e.g., fluorine, chlorine, bromine, or iodine). The halogenated ester may be a linear halogenated ester, such as difluoroethyl acetate, trifluoroethyl acetate, and combinations thereof. A non-halogenated ester is an ester that does not contain any halogen atom(s) (e.g., fluorine, chlorine, bromine, or iodine). The non-halogenated ester may be a linear ester, such as ethyl acetate (EA), n-propyl acetate, n-propyl propionate, n-butyl acetate, methyl propionate (MP), methyl butyrate (MB), ethyl propionate (EP), ethyl butyrate (EB), and combinations thereof.

Non-aqueous electrolyte solvents for the non-aqueous electrolyte of the present disclosure may comprise a carbonate. In various instances, at least one of the carbonates may be a linear carbonate, such as dimethyl carbonate (DMC), diethyl carbonate (DEC), dipropyl carbonate, dibutyl carbonate, ethyl methyl carbonate (EMC), methyl propyl carbonate, and combinations thereof. In various instances, at least one of the carbonates may be a cyclic carbonate, such as ethylene carbonate (EC), fluoroethylene carbonate (FEC), vinylene carbonate (VC), propylene carbonate (PC), butylene carbonate (BC), and combinations thereof. In various instances, the cyclic carbonate may be ethylene carbonate (EC), fluoroethylene carbonate (FEC), or a combination thereof. In various instances, the linear carbonate may be a dialkyl carbonate. In various instances, the dialkyl carbonate may be dimethyl carbonate (DMC), ethyl methyl carbonate (EMC), or a combination thereof. In some instances, the dialkyl carbonate may be dimethyl carbonate (DMC).

As other non-aqueous solvents, there are suitably exemplified one or more selected from cyclic ethers, such as tetrahydrofuran, 2-methyltetrahydrofuran, and 1,4-dioxane; linear ethers, such as 1,2-dimethoxyethane, 1,2-diethoxyethane, and 1,2-dibutoxyethane; amides, such as dimethylformamide; sulfones, such as sulfolane; and lactones, such as γ-butyrolactone, γ-valerolactone, and α-angelicalactone.

Exemplary non-aqueous solvents comprise at least one fluorinated solvent. The fluorinated solvent may be selected from difluoroethyl acetate, trifluoroethyl acetate, N,N-dimethyl trifluoroacetamide, fluoroethylene carbonate (FEC), fluoromethyl methyl carbonate, bis(fluoromethyl) carbonate, difluoromethyl methyl carbonate, 2-fluoroethyl methyl carbonate, difluoromethyl fluoromethyl carbonate, 2,2-difluoroethyl methyl carbonate, bis(2-fluoroethyl) carbonate (DFDEC), ethyl-(2,2-difluoroethyl) carbonate, bis(2,2-difluoroethyl) carbonate, 2,2,2-trifluoroethyl methyl carbonate, ethyl-(2,2,2-trifluoroethyl) carbonate, bis(2,2,2-trifluoroethyl) carbonate, fluorine-containing ethers (e.g., H(CF₂)₂CH₂O(CF₂)₂H, CF₃CF₂CH₂O(CF₂)₂H, H(CF₂)₂CH₂OCF₂CFHCF₃, CF₃(CH₂)₂OCF₂CFHCF₃), and combinations thereof.

In various instances, the non-aqueous solvent may comprise propylene carbonate (PC), ethylene carbonate (EC), n-propyl propionate, diethyl carbonate (DEC), difluoroethyl acetate, or combinations thereof. In various instances, the non-aqueous solvent may further comprise a fluorinated solvent, such as N,N-dimethyl trifluoroacetamide; a solvent comprising a phosphate group, such as trimethyl phosphate (TMP); an ionic liquid, such as a solvent comprising an imidazolium cation, a pyrrolidinium cation, a tetraalkylammonium cation (e.g., N(Et)₄⁺), a tetra fluoroborate anion (BF₄⁻), a hexafluorophosphate anion (PF₆⁻), a dicyanamide anion (dca), a bis(fluorosulfonyl)imide (FSI) anion, or a bis(trifluoromethanesulfonyl)imide (TFSI) anion; or combinations thereof.

Non-aqueous electrolytes for lithium-ion batteries of the present disclosure may further comprise at least one additive that is known in the art to suppress the reactivity of high-Ni compounds in cathodes, reduce gassing, and improve the lithium-ion battery lifetime. At least one additive may be particularly selected to suppress electrolyte flammability. Suitable additives include propane sultone, vinylene carbonate, trimethyl silane (TMS), trimethyl phosphate, adiponitrile, difluoroethyl acetate, trifluoroethyl acetate, tris(2,2,2-trifluoroethyl) phosphate, and combinations thereof.

Non-aqueous electrolytes of the present disclosure may comprise 0.001 wt % to 1.5 wt % of each additive. In various instances, exemplary electrolytes may comprise 0.01 wt % to 3.0 wt % of each additive; 0.05 wt % to 3.0 wt % of each additive; 0.05 wt % to 2.5 wt % of each additive; 0.1 wt % to 2.5 wt % of each additive; 0.1 wt % to 2.0 wt % of each additive; 0.25 wt % to 2.0 wt % of each additive; 0.25 wt % to 1.5 wt % of each additive; 0.5 wt % to 1.5 wt % of each additive; or 0.5 wt % to 1.0 wt % of each additive. In various instances, non-aqueous electrolytes of the present disclosure may comprise no greater than 3.0 wt % of each additive; no greater than 2.5 wt % of each additive; no greater than 2.0 wt % of each additive; no greater than 1.5 wt % of each additive; no greater than 1.0 wt % of each additive; no greater than 0.5 wt % of each additive; no greater than 0.25 wt % of each additive; no greater than 0.05 wt % of each additive; no greater than 0.01 wt % of each additive; or no greater than 0.001 wt % of each additive. In various instances, non-aqueous electrolytes of the present disclosure may comprise no less than 0.001 wt % of each additive; no less than 0.01 wt % of each additive; no less than 0.05 wt % of each additive; no less than 0.1 wt % of each additive; no less than 0.25 wt % of each additive; no less than 0.5 wt % of each additive; no less than 1.0 wt % of each additive; no less than 1.5 wt % of each additive; no less than 2.0 wt % of each additive; no less than 2.5 wt % of each additive; or no less than 3.0 wt % of each additive.

Non-aqueous electrolytes of the present disclosure may be manufactured by using methods known to those of skill in the art.

### III. Lithium-Ion Battery Cells and Battery Packs

Examples of lithium-ion battery cells that may include the lithium-ion battery components (cathode, anode, and non-aqueous electrolyte) are provided below.

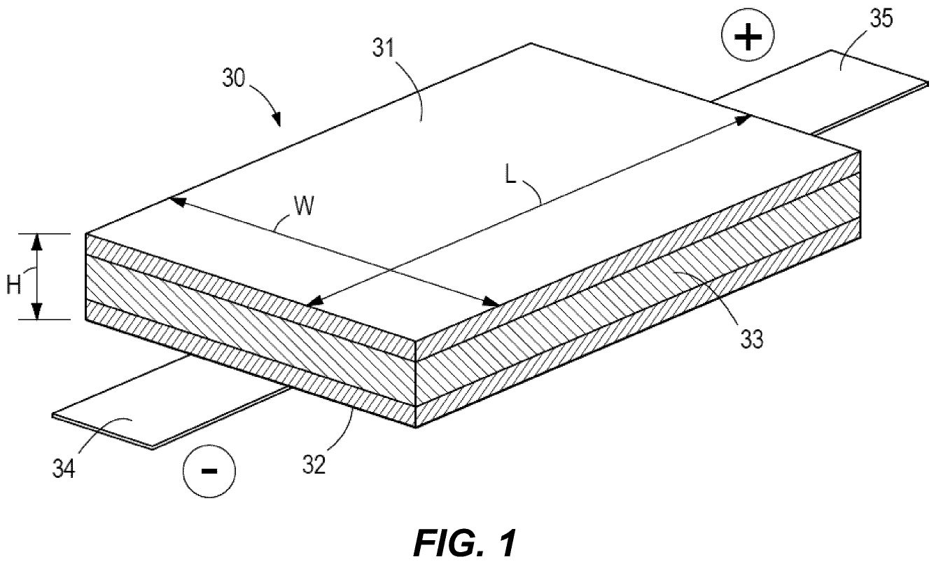

FIG. 1 illustrates a battery cell 30 for a pouch cell comprising a first electrode sheet 31 and a second electrode sheet 32 laminated to respective sides of a polymer-based separator substrate 33. Connection tabs/tapes 34 and 35 are connected to the respective first and second electrodes sheets 31, 32. The first and second electrode sheets 31, 32 may be any of the lithium-polymer cell anode and cathode combinations known in the art. The polymer separator 33 may be a dry solid polymer electrolyte or porous or micro-porous polymer substrate holding a lithium-based electrolyte.

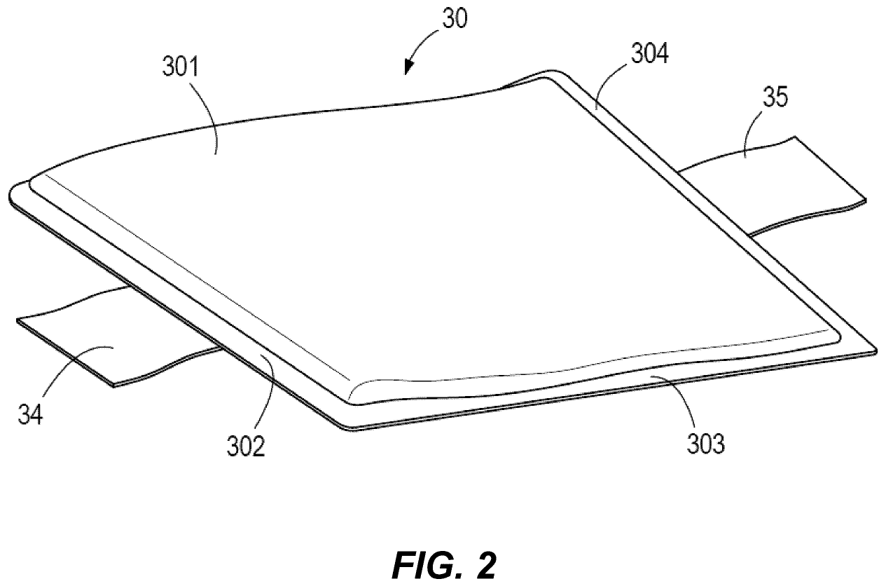

FIG. 2 illustrates a battery cell pouch 301, which is formed from, for example, an aluminum laminate film that is folded around the lithium-ion battery cell 30 and sealed along the three adjoining sides 302, 303, 304. The connection tabs/tapes 34 and 35 protrude from the pouch between the sealed edges of the film. In a battery pack of the present disclosure, a plurality of pouch battery cells 30 (FIGS. 1-2) may be stacked in interconnected groups, where tabs 34,35 of each battery cell 30 may be connected in series and/or parallel. The connection between the respectively terminal tabs 34, 35 of adjacent cells 30 must be of a lower resistance than the internal resistance of the cells 30 and preferably of a very low resistance to prevent heating in the interconnection joint between the cells 30.

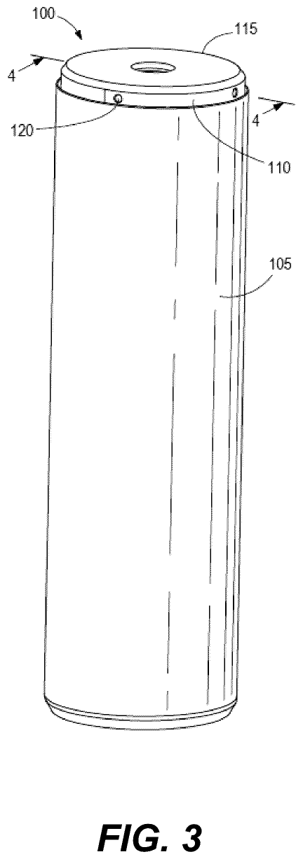

FIG. 3 illustrates a cylindrical (jelly-roll type) battery cell 100. The battery cell 100 is formed by rolling together an anode sheet, a cathode sheet, and an insulation sheet, and may be referred to as a jelly-roll type battery cell. The battery cell 100 may be tabless or tabbed. In some embodiments, an insulation sheet 105 may be provided on the exterior of the battery cell 100. For example, the insulation sheet 105 may be formed of a separator film that is the same separator film used as an insulation sheet that is rolled with electrodes in the battery cell 100. An uncoated portion 110 of an electrode (e.g., an anode and/or a cathode) is provided at a first end of the battery cell 100. The uncoated portion 110 may be provided with at least one passageway 120 that provides an infiltration path for an electrolyte.

The battery cell 100 may have a nominal voltage between approximately 1 V and approximately 5 V, and a nominal capacity between about 1 Ah and about 5 Ah or more (e.g., up to about 9 Ah). The battery cell 100 may have various rechargeable chemistry types.

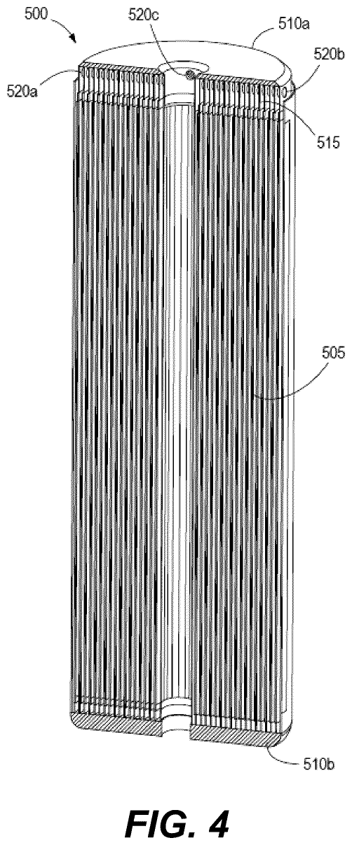

FIG. 4 illustrates a cross-sectional view of a battery cell 500, according to some embodiments. The battery cell 500 may be substantially the same as battery cell 100 shown in FIG. 3. The battery cell 500 includes a rolled electrode assembly 505, a first rubbing region 510a, a second rubbing region 510b, an uncoated portion 515, and passageways 520a, 520b, 520c. As described above, an electrolyte (not shown) is generally introduced into the concentric layers of the electrode assembly 505. The electrolyte facilitates movement of the lithium-ions between the anode sheet and the cathode sheet.

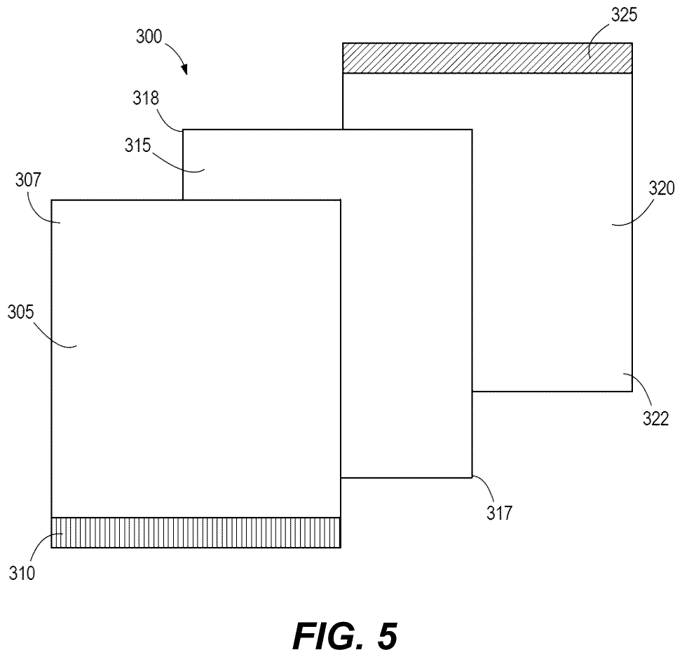

FIG. 5 illustrates example electrode sheets included in an example tabless electrode assembly 300. Typically, tabless electrode assemblies may not include a traditional battery tab that is attached to both the anode and the cathode, which connect the anode and the cathode to a battery terminal. Battery designs using tabbed configurations may have increased resistance due to the required tabs, resulting in reduced current capacity of the battery. Thus, tabless electrode assemblies, such as tabless electrode assembly 300, may have a reduced impedance between an output terminal and the anode and/or cathode, resulting in an increased current capacity over a tabbed battery configuration. The electrode assembly 300 includes an anode sheet 305, a separator sheet 315, and a cathode sheet 320. The separator sheet 315 is interspersed between the anode sheet 305 and the cathode sheet 320. The separator sheet 315 is a medium that allows the passage of ions between the anode sheet 305 and the cathode sheet 320. For example, in a lithium-ion battery cell, the separator sheet 315 allows lithium-ion atoms to pass through while blocking electrons from passing through. In various instances, the separator sheet 315 may have a thickness of 20 micrometers. However, thicknesses of more than 20 micrometers or less than 20 micrometers are also contemplated. In various instances, the separator sheet 315 may be made of polyethylene (PE), polypropylene (PP), or other material suitable for a given application.

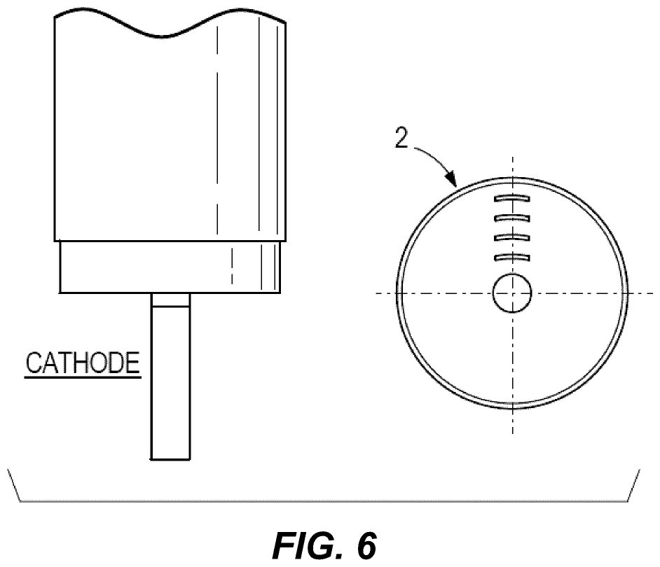

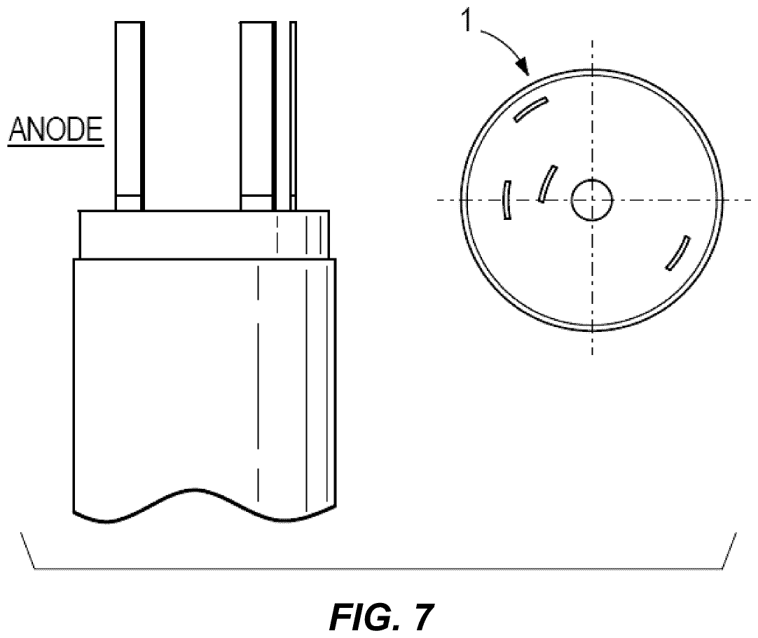

FIG. 6 and FIG. 7 are directed to a tabbed battery, where a tab is attached to the anode and/or the cathode, wherein the tab connects the anode and/or the cathode to a battery terminal. FIG. 6 shows a cathode tab arrangement wherein the tabs are arranged in alignment. FIG. 7 shows an anode tab arrangement wherein the tabs are arranged in a radial pattern.

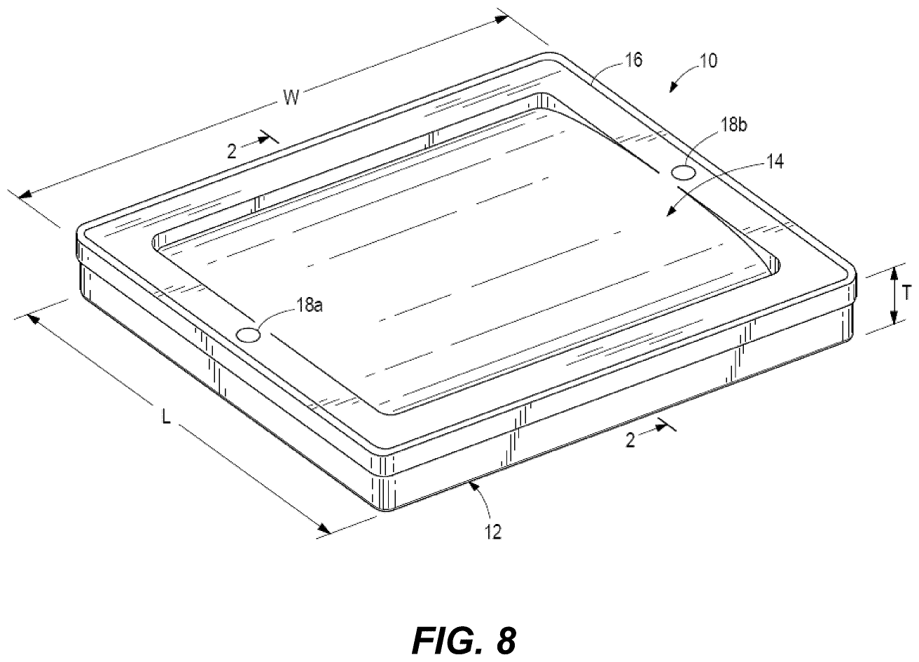

FIG. 8 illustrates prismatic cell 10, which has an outer housing made up of a can 12 and a cover 14. The housing has a length, L, a width, W, and an overall thickness, T. During assembly of the prismatic cell, cover 14 is pressed into can 12 and welded along joint 16 to seal the cell. Contacts 18a and 18b assembled in holes in cover 14 are in electrical communication with positive and negative electrodes, respectively, within the cell. The contacts are both electrically isolated from the housing, such that the cell is “case neutral.” Both cover 14 and can 12 are of stamped 304 metal %.

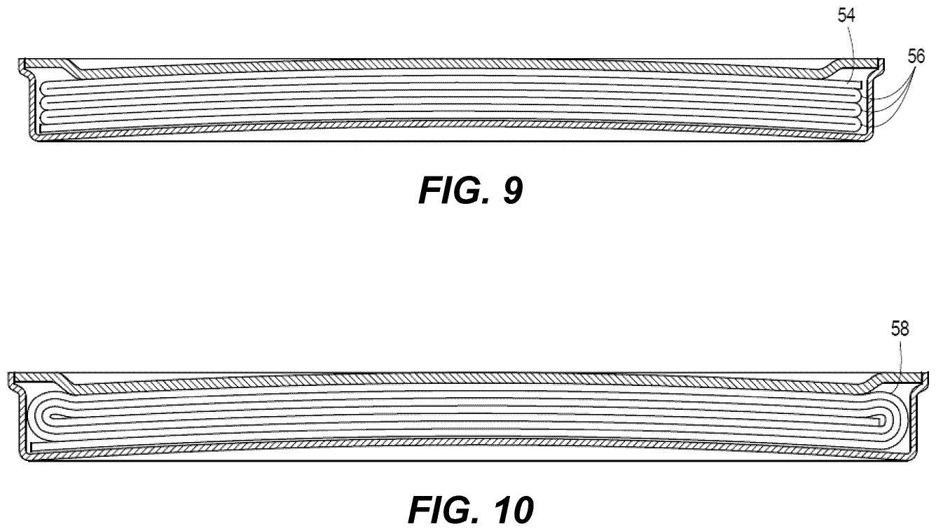

FIGS. 9 and 10 illustrate alternate folding arrangements of electrode stacks within prismatic cells. As shown in FIGS. 9 and 10, prismatic cells, the stacked electrode sheets may be either folded back and forth (FIG. 9) or rolled up (FIG. 10). The configuration of electrode stack 54 having 180-degree bends (56) in FIG. 9 may be referred to as fan fold (i.e., accordion fold, zig-zag fold), while the electrode stack 58 in FIG. 10 may be referred to as wound flat wrap (WFW).

Lithium-ion batteries of the present disclosure may deliver varying Watt-hours/Liter (Wh/L). In various instances, the lithium-ion battery cell delivers at least 300 Wh/L. In various instances the lithium-ion battery of the present disclosure delivers at least 350 Wh/L; at least 375 Wh/L; at least 400 Wh/L; at least 425 Wh/L; at least 450 Wh/L; at least 475 Wh/L; at least 500 Wh/L; at least 525 Wh/L; at least 550 Wh/L; at least 575 Wh/L; at least 600 Wh/L; at least 625 Wh/L; at least 650 Wh/L; at least 675 Wh/L; at least 700 Wh/L; at least 725 Wh/L; at least 750 Wh/L; at least 775 Wh/L; or at least 800 Wh/L.

Lithium-ion batteries of the present disclosure may output varying Kilowatt-hours/Liter (KWh/L). In various instances, the lithium-ion battery cell outputs at least 4.0 KWh/L. In various instances the lithium-ion battery of the present disclosure outputs at least 4.25 KWh/L; at least 4.50 KWh/L; at least 4.75 KWh/L; at least 5.0 KWh/L; at least 5.25 KWh/L; at least 5.50 KWh/L; at least 5.75 KWh/L; at least 6.0 KWh/L; at least 6.25 KWh/L; at least 6.50 KWh/L; at least 6.75 KWh/L; at least 7.0 KWh/L; at least 7.25 KWh/L; at least 7.50 KWh/L; at least 7.75 KWh/L; at least 8.0 KWh/L; at least 8.25 KWh/L; at least 8.50 KWh/L; at least 8.75 KWh/L; or at least 9.00 KWh/L. Exemplary lithium-ion batteries of the present disclosure output 4.5 KWh/L to 8.5 KWh/L.

The lithium-ion battery cells of the present disclosure may be included in battery pack. The battery packs of the present disclosure comprise at least one tabbed or tabless cylindrical (jelly-roll type) cell, pouch cell (wound/rolled type cell in a flexible pouch package), or prismatic cell (wound/rolled type cell in a rigid package). The battery cells within the battery pack may be connected in series and/or in parallel.

The lithium-ion batteries and battery packs of the present disclosure may be manufactured using methods known to those of skill in the art. The battery packs of the present disclosure may be constructed in various ways, depending on the specific battery pack and the intended use of said battery pack. For instance, the lithium-ion battery cell core (or stack) may be coupled to a circuit board and a terminal block and placed inside of an outer housing. The outer housing may comprise a rigid plastic. The outer housing may further comprise a less-rigid (i.e., softer) overmolding (e.g., a rubber) that may function to protect the battery pack of the present disclosure from impact. In various instances, the battery packs of the present disclosure include a top housing, a bottom housing, a cell pad, a plurality of battery cells, a harness, and a circuit board, as described in U.S. Pat. No. 8,764,852, the entire contents of which is hereby incorporated by reference.

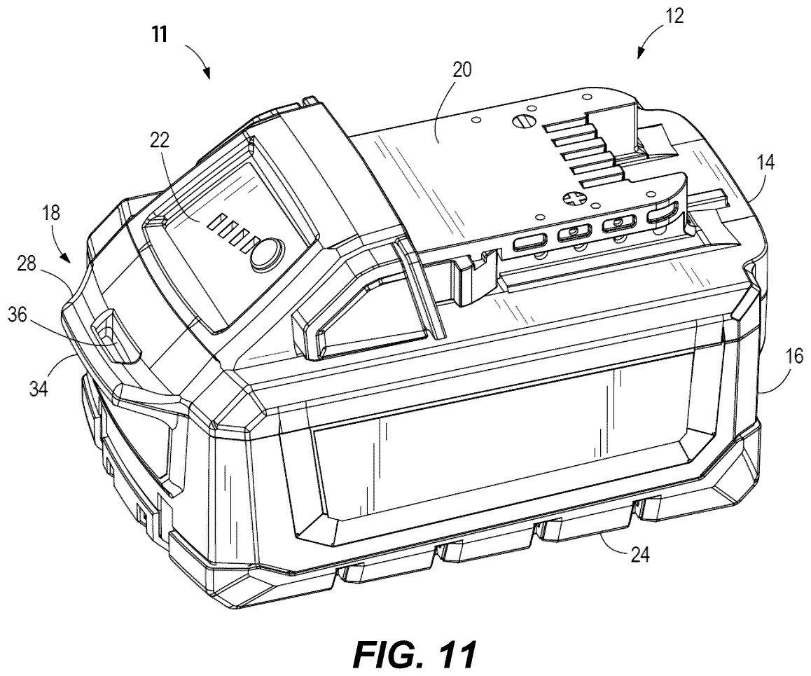

FIGS. 11-14, illustrate perspective views of various exemplary battery packs containing lithium-ion battery cells.

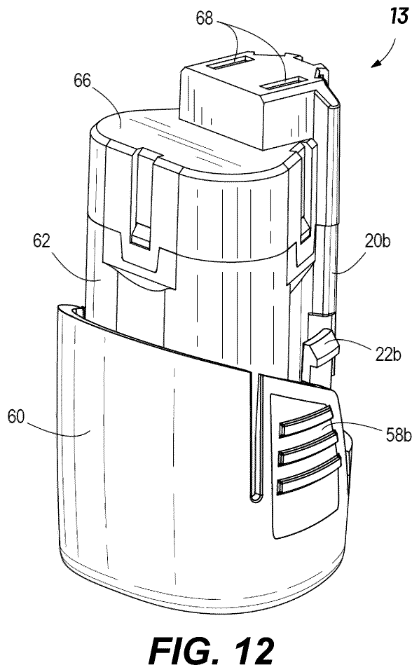

FIG. 11 illustrates an exemplary battery pack 11 (e.g., a Milwaukee Tool M18® battery pack) includes a housing assembly 12 having a tether-receiving structure or tether receiver 18. The housing assembly 12 includes an upper housing portion 14 and a lower housing portion 16. The housing assembly 12 is configured to couple the upper housing portion 14 to the lower housing portion 16 and define a cavity, or recess 32, within the interior surfaces of the housing assembly 12. The upper housing portions 14 and lower housing portion 16 may be molded from a plastic material such as polyethylene. The upper housing portion 14 and lower housing portion 16 may be made of the same or different materials. The upper housing portion 14 may attach to the lower housing portion 16 to form the battery housing assembly 12. The housing assembly 12 includes a vertical axis through a midpoint of the housing. The vertical axis divides the housing into a first side and a second side (e.g., a front and a back). The housing assembly 12 includes a horizontal axis through the midpoint of the housing assembly 12 that divides the housing assembly 12 into an upper half and a lower half. In some embodiments, the upper half corresponds to the upper housing portion 14 and the lower half corresponds to the lower housing portion 16. In other embodiments, the upper housing portion 14 and lower housing portion 16 are coupled above or below the horizontal axis. Housing assembly 12 may include a tether receiver 18, a power tool receiver 20, a status indicator 22, a bumper 24, one or more battery cells 26 enclosed within housing assembly 12, and/or other components. As illustrated in FIG. 12, housing assembly 12 includes a tether receiver 18 for connecting a tether to the battery 11. The tether receiver 18 may be formed on a side of the battery opposite the power tool receiver 20. In some embodiments, the tether receiver 18 includes a lip or protrusion 28 extending outwardly from a wall. The receiver further includes a bridge 34 that extends across protrusion 28 and forms an opening 36. Opening 36 extends completely through the protrusion 28 to allow a tether or lanyard to connect to and/or pass-through tether receiver 18. Battery pack 11 may function as described in U.S. Patent Application Publication No. 2020/0227695, the entire contents of which is hereby incorporated by reference.

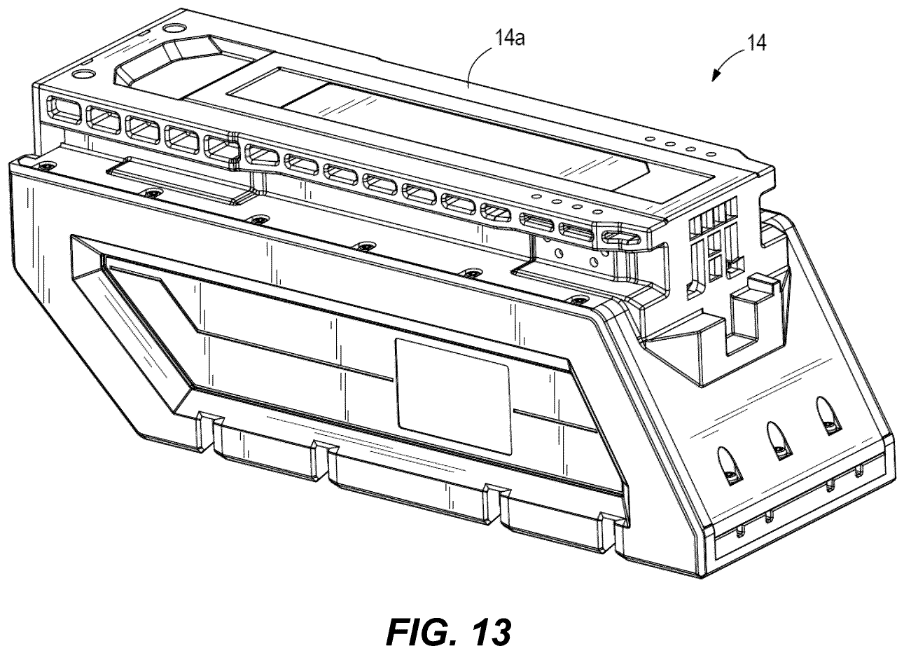

FIG. 13 illustrates an exemplary battery pack 13 (e.g., a Milwaukee Tool M12® battery pack) that may be removably and interchangeably connected to the tool to provide power during operation and to facilitate recharging of the battery pack 13 when not in use. Battery pack 13 may function and be designed as described in U.S. Pat. No. 10,276,844, the entire contents of which is hereby incorporated by reference.

In some constructions, the battery pack 13 may be used with other types of cordless, battery-powered tools or devices not specifically discussed herein. &The illustrated battery pack 13 includes a casing 62, an outer housing 60 coupled to the casing 62, and a plurality of battery cells positioned within the casing 62. The casing 62 is shaped and sized to fit within the cavity 16 in a tool to connect the battery pack 13 to said tool. The casing 62 includes an end cap 66 to substantially enclose the battery cells 64 within the casing 62. In one construction, the battery circuit operates as illustrated and described in U.S. Pat. No. 7,157,882, the entire contents of which are hereby incorporated by reference. In another construction, the battery circuit operates as illustrated and described in U.S. Pat. No. 7,589,500, the entire contents of which are also hereby incorporated by reference.

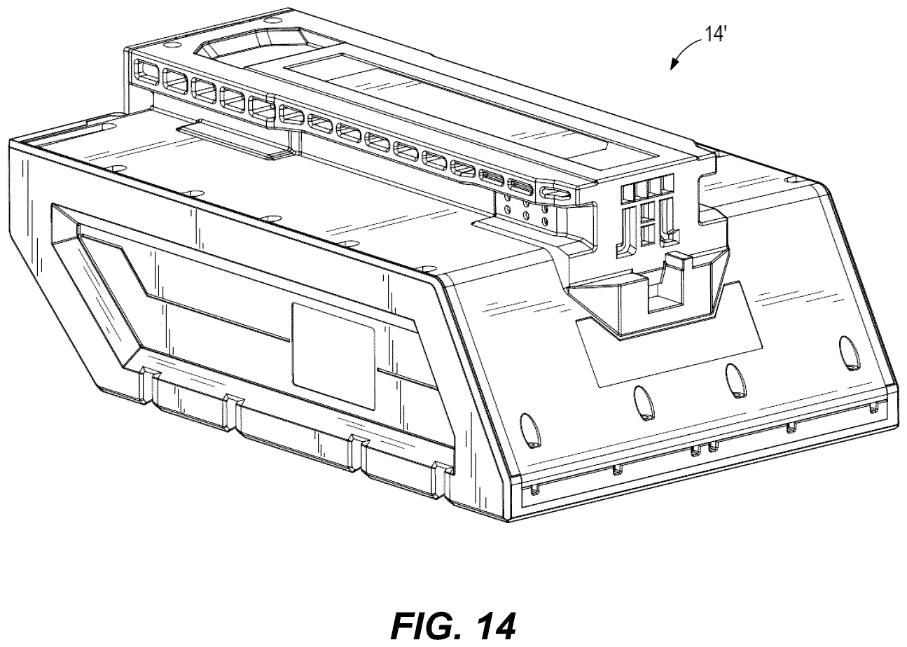

FIGS. 14 and 15 illustrate battery packs 14 and 14′ (e.g., a Milwaukee tool MX FUEL® battery pack), which are similar to the battery packs and interfaces described and illustrated in U.S. Pat. No. 11,179,841, the entire contents of which is hereby incorporated by reference. The battery pack 14 and 14′ may be any type of battery pack (e.g., battery packs that include a single cell string (1P), two parallel cell strings (2P), three parallel cell strings (3P)).

The foregoing description of the specific aspects will so fully reveal the general nature of the technology that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary aspects but should be defined only in accordance with the following claims and their equivalents.

For reasons of completeness, various aspects of the present disclosure are set out in the following numbered embodiments (embodiment 1 is denoted E1, embodiment 2 is denoted E2, etc.):
E1. A jelly-roll type lithium-ion battery cell comprising:
   a cathode comprising a mixed metal oxide active material of formula:

LiNiₓM′₍₁₋ₓ₎O₂
where M′ is at least one metal element and 0.83≤x≤0.999;
   an anode comprising an active material, the active material comprising carbon; and
   a non-aqueous electrolyte.
E2. The jelly-roll type lithium-ion battery cell of E1, wherein the anode further comprises silicon.
E3. The jelly-roll type lithium-ion battery of E1 or E2, wherein the anode comprises at least 4wt % silicon.
E4. The jelly-roll type lithium-ion battery of any one of E1-E3, wherein the battery delivers at least 650 Watt-hours/Liter (Wh/L).
E5. The jelly-roll type lithium-ion battery of any one of E1-E4, wherein the battery delivers at least 700 Wh/L.
E6. The jelly-roll type lithium-ion battery of any one of E1-E5, wherein the battery outputs no less than 7.5 Kilowatt-hours/Liter (KWh/L).
E7. The jelly-roll type lithium-ion battery of any one of E1-E6, wherein the battery outputs no less than 8.0 KWh/L.
E8. The jelly-roll type lithium-ion battery of any one of E1-E7, wherein the battery outputs no less than 8.5 KWh/L.
E9. The jelly-roll type lithium-ion battery of any one of E1-E8, wherein the cathode delivers no less than 1.9 Watt-hours/cubic centimeter (Wh/cc).
E10. The jelly-roll type lithium-ion battery of any one of E1-E9, wherein the cathode discharges no less than 35 mA/cm².
E11. The jelly-roll type lithium-ion battery of any one of E1-E10, wherein the cathode discharges no less than 38 mA/cm².
E12. A battery pack comprising:
   at least one lithium-ion battery cell comprising:
      a cathode comprising a mixed metal oxide active material of formula:

LiNiₓM′₍₁₋ₓ₎O₂
where M′ is at least one metal element and 0.83≤x≤0.999;
   an anode comprising an active material, the active material comprising carbon; and
   a non-aqueous electrolyte.
E13. The battery pack of E12, wherein at least one lithium-ion battery cell is at least two lithium-battery cells connected in series.
E14. The battery pack of E12 or E13, wherein at least one lithium-ion battery cell is at least two lithium-battery cells connected in parallel.
E15. The battery pack of any one of E12-E14, wherein the anode further comprises at least 4 wt % silicon.
E16. A lithium-ion battery cell comprising:
   a cathode comprising a mixed metal oxide active material, the mixed metal oxide

LiNiₓM′₍₁₋ₓ₎O₂
wherein M′ is at least one metal element, and 0.83≤x≤0.999;
   an anode comprising an active material, the active material comprising carbon and at least 4 wt % silicon; and
   a non-aqueous electrolyte.
E17. The lithium-ion battery cell of E16, wherein the lithium-ion battery cell delivers at least 400 Wh/L.
E18. The lithium-ion battery cell of E16 or E17, wherein the lithium-ion battery cell delivers at least 450 Wh/L.
E19. The lithium-ion battery cell of any one of E16-E18, wherein the lithium-ion battery cell outputs no less than 4.5 KWh/L.
E20. The lithium-ion battery cell of any one of E16-E19, wherein the cathode discharges no less than 35 mA/cm².

1. A jelly-roll type lithium-ion battery cell comprising:
a cathode comprising a mixed metal oxide active material of formula:
LiNiₓM′₍₁₋ₓ₎O₂
where M′ is at least one metal element and 0.83≤x≤0.999;
an anode comprising an active material, the active material comprising carbon; and
a non-aqueous electrolyte.

2. The jelly-roll type lithium-ion battery cell of claim 1, wherein the anode further comprises silicon.

3. The jelly-roll type lithium-ion battery of claim 2, wherein the anode comprises at least 4 wt % silicon.

4. The jelly-roll type lithium-ion battery of claim 3, wherein the battery delivers at least 650 Watt-hours/Liter (Wh/L).

5. The jelly-roll type lithium-ion battery of claim 1, wherein the battery delivers at least 700 Wh/L.

6. The jelly-roll type lithium-ion battery of claim 1, wherein the battery outputs no less than 7.5 Kilowatt-hours/Liter (KWh/L).

7. The jelly-roll type lithium-ion battery of claim 1, wherein the battery outputs no less than 8.0 KWh/L.

8. The jelly-roll type lithium-ion battery of claim 1, wherein the battery outputs no less than 8.5 KWh/L.

9. The jelly-roll type lithium-ion battery of claim 1, wherein the cathode delivers no less than 1.9 Watt-hours/cubic centimeter (Wh/cc).

10. The jelly-roll type lithium-ion battery of claim 1, wherein the cathode discharges no less than 35 mA/cm².

11. The jelly-roll type lithium-ion battery of claim 1, wherein the cathode discharges no less than 38 mA/cm².

12. A battery pack comprising:
at least one lithium-ion battery cell comprising:
a cathode comprising a mixed metal oxide active material of formula:
LiNiₓM′₍₁₋ₓ₎O₂
where M′ is at least one metal element and 0.83≤x≤0.999;
an anode comprising an active material, the active material comprising carbon; and
a non-aqueous electrolyte.

13. The battery pack of claim 12, wherein at least one lithium-ion battery cell is at least two lithium-battery cells connected in series.

14. The battery pack of claim 12, wherein at least one lithium-ion battery cell is at least two lithium-battery cells connected in parallel.

15. The battery pack of claim 12, wherein the anode further comprises at least 4 wt % silicon.

16. A lithium-ion battery cell comprising:
a cathode comprising a mixed metal oxide active material, the mixed metal oxide
LiNiₓM′₍₁₋ₓ₎O₂
wherein M′ is at least one metal element, and 0.83≤x≤0.999;
an anode comprising an active material, the active material comprising carbon and at least 4 wt % silicon; and
a non-aqueous electrolyte.

17. The lithium-ion battery cell of claim 16, wherein the lithium-ion battery cell delivers at least 400 Wh/L.

18. The lithium-ion battery cell of claim 16, wherein the lithium-ion battery cell delivers at least 450 Wh/L.

19. The lithium-ion battery cell of claim 16, wherein the lithium-ion battery cell outputs no less than 4.5 KWh/L.

20. The lithium-ion battery cell of claim 16, wherein the cathode discharges no less than 35 mA/cm².
